(19) United States
(12) Patent Application Publication
(10) Pub. No.: US 2003/0059009 A1
(43) Pub. Date: Mar. 27, 2003

(54) Modular multi-media communication management system with context dependent multi-media help functionality

(75) Inventors: Robert F. Meyerson, Naples, FL (US); Calvin E. Lewis, Copley, OH (US)

Correspondence Address: PATTON BOGGS, PO BOX 270930, LOUISVILLE, CO, 80027, US

(73) Assignee: Teleware, Inc.

(21) Appl. No.: 10/037,913

(22) Filed: Jan. 4, 2002

Related U.S. Application Data
(63) Continuation-in-part of application No. 09/961,532, filed on Sep. 24, 2001.

(51) Int. Cl. H04M 11/00

(52) U.S. Cl. 379/93.17

(57) ABSTRACT

The present multi-media communication system comprises a controller that interfaces with a plurality of communication space stations and with one or more communication medium service providers. Each communication space station includes a subscriber voice interface and a help button. Further, each communication space station is configurable to include a graphic display screen and may server a subscriber device that includes a graphic display screen. The controller provides help information to the subscriber station in response to subscriber activation of the help button that is dependent on the operational state of the communication space station and is compliant with the communication space station's subscriber interface. The controller further provides for establishing a communication session with a help station in response to a second subscriber activation of the help button.

### CROSS REFERENCE TO RELATED APPLICATIONS

The present application is a continuation in part of U.S. patent application Ser. No. 09/961,532 titled “Teledata Space and Docking Station with Modular and Integrated Display”, filed on Sep. 24, 2001, the contents of such patent application is incorporated herein.

### TECHNICAL FIELD

The present invention relates generally to managing multi-media communications, and more particularly to providing multi media help functions contextually related to the subscriber's needs.

### BACKGROUND OF THE INVENTION

In today's computerized world, many systems provide help file functionality. For example, typical desk top computer operating systems include a help icon on each screen which, when activated by the user, opens a window that includes help information. It is common for the help information to be related to the particular screen from which the help icon was activated. The information typically comes from help files that are stored locally on the computer or may be retrieved and/or updated on the Internet. The help files consist of display content or animated display content (to emulate user activation of screen controls) because the software is designed for operation on a desk top or notebook computer that will invariably have a display adequate for display of the display content.

In addition to providing help files, some software programs, such as the AOL® client provide on-line live support staff so that a user may open an instant message window with a customer service representative to obtain assistance using the software. This is useful when the user does not understand the contents of the help files or needs assistance with a matter not covered in the help files. Again, the help content is delivered on the display screen through the instant message window.

Other computer systems such as an “automated touch tone” system interact with the user through a telephone voice interface rather than through a desk top computer with a keyboard, mouse, and display screen. Automated touch tone systems are commonly used to provide users with account information, airline flight information, and other information using a simulated voice over the telephone. The user navigates a menu of choices in response to voice prompts using the DTMF tones of the telephone. Typically, the choices will always include a prompt similar to “press zero to speak to a customer service representative” After pressing zero, the user is placed in a queue for a customer service representative.

A problem is that neither of the above described systems are adequate for providing help information to various subscribers to a complex multi-media communications management system wherein the subscriber stations and devices utilized by each of a plurality of subscribers have differing permutations of audio and display interface capabilities. What is needed is a modular and configurable multi media communication management system that not only allows for operator selection of modules and subscriber interface configurations tailored to the subscriber's communication needs, but also allows for delivery of operator help content that is relevant to the subscriber devices operational state and delivered in a multi media format that is compatible with the subscriber device's interface configuration.

### SUMMARY OF THE INVENTION

The present multi-media communication management system comprises a controller that interfaces with a plurality of communication space stations and with one or more communication medium service providers. The controller translates multi-media communications received from a multi-media service provider into the protocols required for use by the communication space stations as well as any conventional telephone stations that may be coupled to the controller. The communication and control signaling between the controller and the communication space stations may be wireless in nature with the communication space stations being powered by an internal battery and/or connection to a local source of conventional line voltage.

The controller further provides context dependent help information to the communication space stations in response to subscriber activation of a help button that is included on the communication space station. Further, the controller may establish a communication session with a support help station in response to subscriber activation of the help button a second time and may relay communications between the communication session the support help station and a communication session with the subscriber station. Alternatively, the controller may provide instructions to the communication space station to establish a communication session the support help station in response to subscriber activation of the help button a second time.

The architecture of the communication space station is modular. Multiple functional elements can be interconnected with backbone communication circuitry to form an integrated communication platform that may include a graphic subscriber interface in addition to a subscriber voice interface. Further, a modular docking interface may be used to couple the communication space station to portable subscriber devices that may include a graphic subscriber interface.

The help information provided by the controller is compliant with the subscriber interface configuration of the communication space station.

For a better understanding of the present invention, together with other and further aspects thereof, reference is made to the following description, taken in conjunction with the accompanying drawings, and its scope will be pointed out in the appended clams.

### BRIEF DESCRIPTION OF THE DRAWINGS

FIG. 1 is a block diagram view of a modular multi-media communication management system in accordance with one embodiment of the present invention;

FIG. 2 is a bock diagram view of a portions of a modular multi-media communication management system useful for providing a help function in accordance with one embodiment of the present invention;

FIG. 3 is a perspective exploded view of a modular communication space station in accordance with one embodiment of the present invention;

FIG. 4 is a block diagram of a communication space station in accordance with one embodiment of the present invention;

FIG. 5 is a block diagram of a multi-media communication management system controller in accordance with one embodiment of the present invention;

FIG. 6 is a block diagram of a subscriber data assistant in accordance with one embodiment of the present invention;

FIG. 7 is a block diagram of a wide area network communication device in accordance with one embodiment of the present invention;

FIG. 8 is a block diagram of a wireless voice handset in accordance with one embodiment of the present invention;

FIG. 9a is a table diagram representing an exemplary state of operation of a communication management system in accordance with one embodiment of the present invention;

FIG. 9b is a table diagram representing an exemplary state of operation of a communication management system in accordance with one embodiment of the present invention;

FIG. 9c is a table diagram representing an exemplary state of operation of a communication management system in accordance with one embodiment of the present invention; and

FIG. 9d is a table diagram representing an exemplary state of operation of a communication management system in accordance with one embodiment of the present invention.

### DESCRIPTION OF THE PREFERRED EMBODIMENTS

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

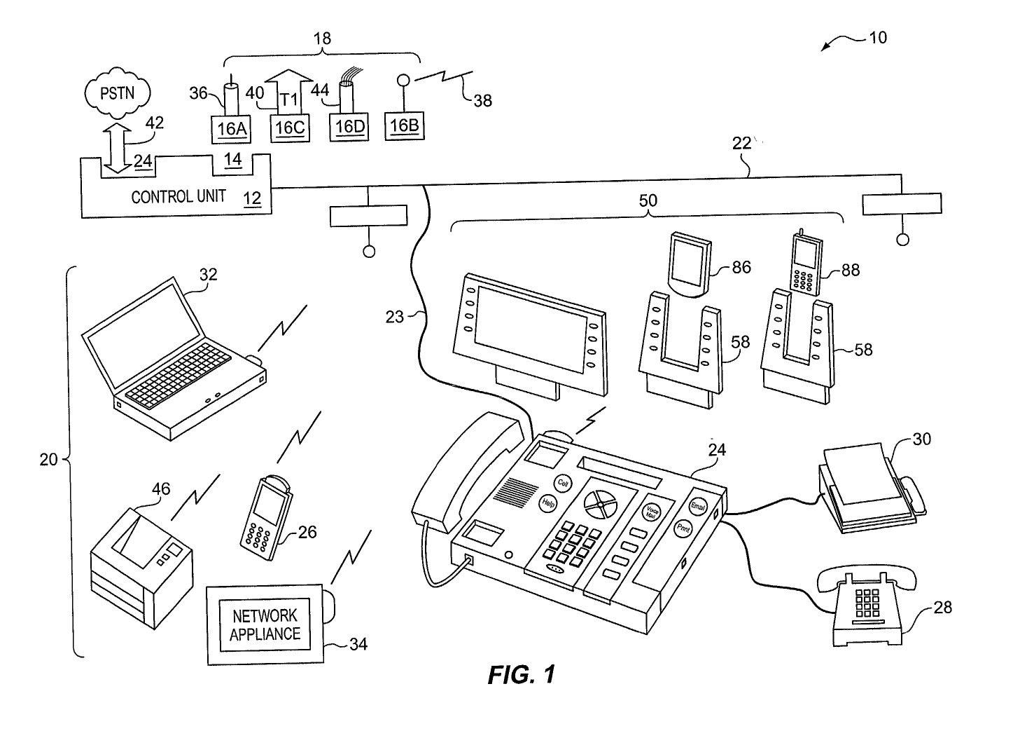

Referring to FIG. 1, an exemplary architecture of the multi-media communication management system 10 of the present invention is shown. The multi-media communication management system 10 includes a control unit 12 that is coupled with a plurality of local communication devices 20 over a wireless local area network 22 (or by a wired network connection 23 to the backbone wired network of the wireless local area network 22). The local communication devices 20 may include: subscriber stations 24 (communication space stations 24), wireless voice handsets 26, traditional telephone handsets 28 & traditional fax machines 30 (both coupled through communication space station 24), traditional computer systems 32, network printers 46, and various network appliances 34.

The control unit 12 includes a multi-media communication service provider bay 14 that operatively couples one of a plurality of communication medium modules 16a-16d to the control unit 12. Each communication medium module 16a-16d is configured to interface with a service provider's multi-media communication medium 18a-18d. For purposes of illustration, communication module 16(a) may be a cable modem module for communicating over coaxial cable 36 with a multimedia communication service provider such as a local cable company, communication module 16(b) may be a wide area network radio for communication over a wireless spectrum channel 38 with a wide area wireless multi-media communication service provider such as an analog or digital cellular/PCS telephone service provider, communication module 16c may be a customer service unit (CSU) for communication over a T1 line 40 with a multi-media communication provider such as a local telephone service provider, and communication module 16d may be an optical modem for communication over a fiber channel 44 with a fiber optic multimedia communication service provider. It should be appreciated that the examples of communication modules 16a-16d are for illustrative purposes only and it is recognized that multi-media communication services may be provided by other service providers utilizing other communication technologies such as satellite RF or other. For purposes of this invention, a communication module 16 includes circuitry for interfacing between the control unit 12 and a selected multi-media communication service provider. The control unit 12 further comprises a circuit switched provider bay 24 which operatively couples one or more public switched telephone network (PSTN) channels 42.

In operation, the control unit 12 integrates and manages multi-media communication between the local communication devices 20 and between each local communication device 20 and a remote service provider (not shown) over the service provider's multi-media communication medium 18. More specifically, the control unit 12 translates received multi-media communication signals from the multi-media communication medium 18 (or a source local device 20) to the protocols required for use by the destination local communication device 20 (or the multi-media communication medium 18).

Communication Space Station

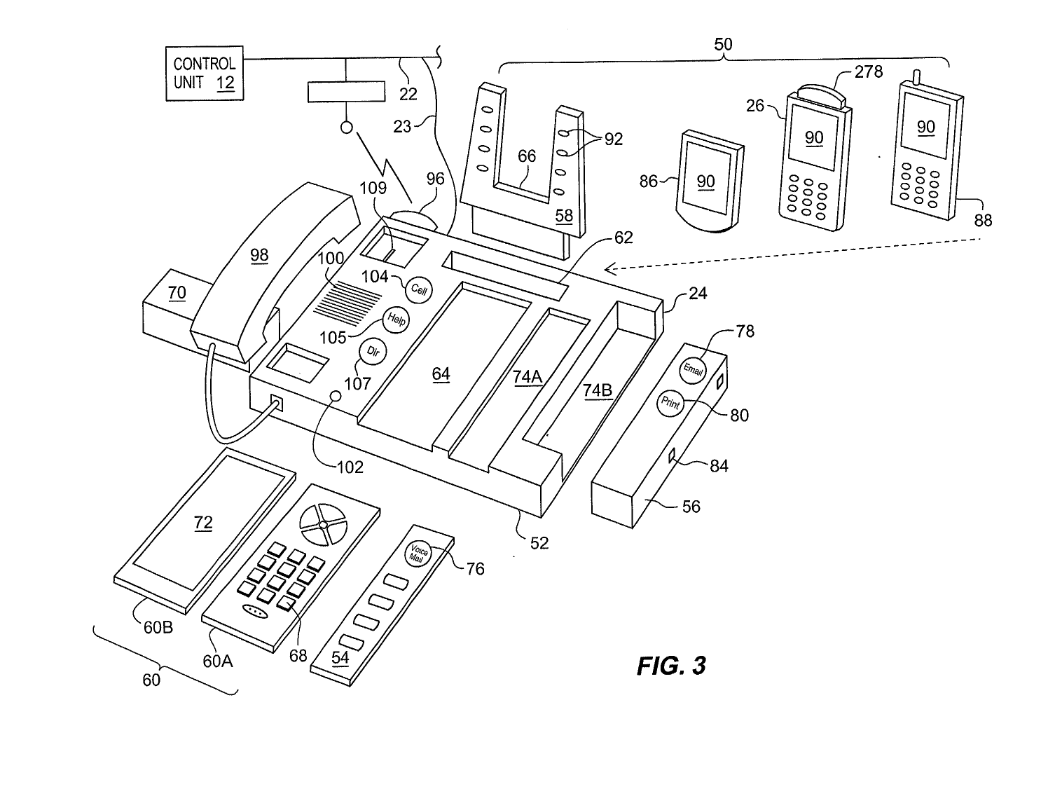

Referring to FIG. 3, a perspective view of an exemplary communication space station 24 is shown. The communication space station 24 includes a platform unit 52 that operatively couples to the control unit 12 via either a wireless communication link between a platform unit network circuit 96 and the wireless network 22 or a direct network connection 23 between the platform unit 52 and the backbone network of the wireless network 22.

A plurality of functional modules 54, 56, 58, and 60 may be coupled to the platform unit 52 to form an integrated multi-media communication platform. The platform unit 52 includes a subscriber interface docking platform 64 for coupling and optionally supporting one of a plurality of modular subscriber interface units 60 to the platform unit 52. The modular subscriber interface unit 60a may include a plurality of buttons 68 in an arrangement similar to a typical telephone key pad to provide for subscriber input in a manner similar to that of a traditional telephone handset. The modular subscriber interface 60b may include a touch panel graphic display 72 to provide for subscriber input through virtual buttons visible thereon.

The platform unit 52 further includes a first function specific docking platform 74a and a second function specific docking platform 74b, each of which couples to a plurality of function specific modules 54 and 56. The first function specific docking platform 74a is a shallow platform for coupling to function specific modules that primarily comprise function specific buttons or other circuits that may be placed within a thin module. The second function specific docking platform 74b is a larger platform for coupling to function specific modules with more complex internal circuits requiring the additional size.

In the exemplary embodiment, the function specific module 54 may include subscriber interface buttons configured for enhancing voice communication through the communication space station 24 such as a voice message control 76 for single button access to voice message files and voice management controls 86 for single button control of enhanced voice management functions.

The function specific module 56 may include circuits configured for enhancing data communication through the communication space station 24 such as an electronic message control 78 for single button access to subscriber electronic messages, a print control 80 for single button initiation of the printing of a subscriber electronic message file, and a data networking port 84.

The platform unit 52 further includes a docking bay 62 into which a modular docking interface 58 may be secured and operatively coupled to the platform unit 52. The modular docking interface 58 supports one of a plurality of modular subscriber devices 50 within a subscriber device interface bay 66 and provides for operatively coupling the modular subscriber device 50 to the platform unit 52. Exemplary configurations for the modular subscriber device 50 include a subscriber data assistant 86, a subscriber wide area network communication device 88, and the wireless LAN voice handset 26, each of which is discussed in more detail herein.

While operatively coupled to the platform unit 52, the subscriber device 50 becomes an integral part of the subscriber interface of the communication space station 24. A liquid crystal graphic display 90 on the subscriber device 50 may function to display multi-media communication management information under control of the platform unit 52 and the control unit 12. Further, programmable subscriber controls 92 positioned adjacent to the subscriber device 50 may be configured to activate platform unit 52 and control unit 12 functions in accordance with the contents of the graphic display 90 adjacent to the controls 92.

The platform unit 52 may further include one or more of the following elements: a) a handset 98 similar to a traditional telephone handset to provide a subscriber voice interface, b) a speaker 100 and a microphone 102 to provide a hands-free subscriber voice interface, c) a modular battery pack 70 (which fits within a battery pack bay that is not shown) for operating power when the communication space station 24 is uncoupled from a line voltage, d) cell button 104 for single button selection of certain functions such as a wide area network communication function, and e) help button 106 for single button selection of a help function.

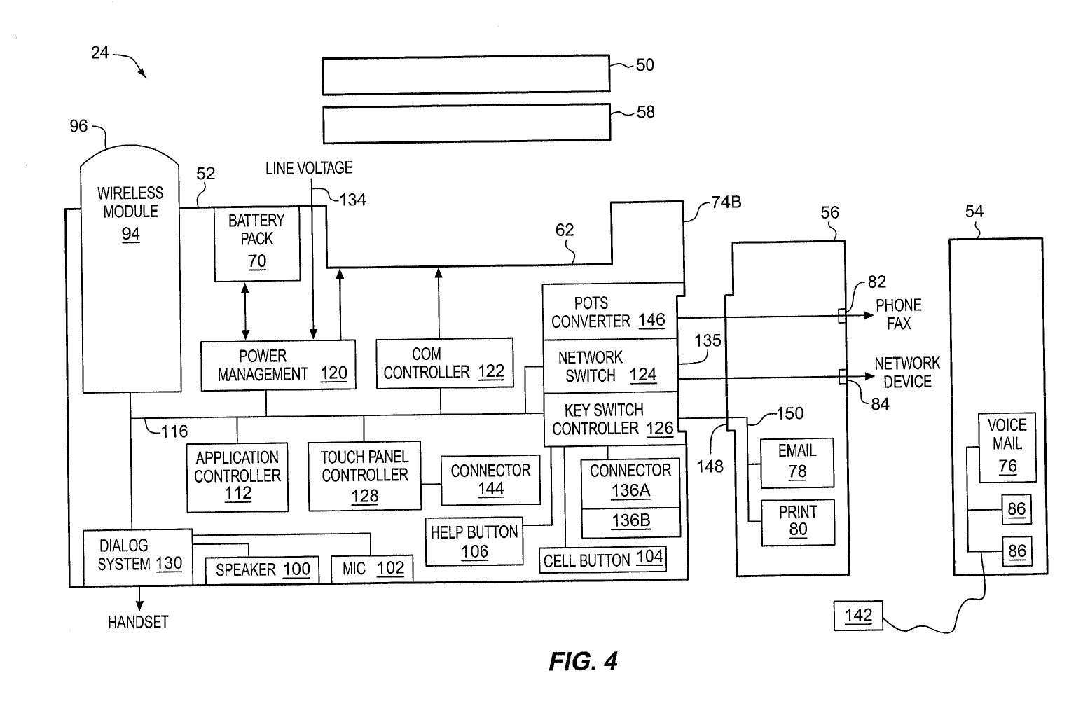

FIG. 4 shows a block diagram of the communication space station 24. The platform unit 52 includes an application controller 112 coupled to a local bus 116 that interconnects the application controller 112 with a plurality of peripheral circuits that include a wireless module 94, a power management controller 120, a communication controller 122, a network switch controller 124, a key switch controller 126, a touch panel controller 128, a plain old telephone service (POTS) converter 146, and a voice communication system 130.

The wireless module 94 operatively couples the platform unit 52 with the control unit 12 over the wireless LAN 22 (both of FIG. 1). The application controller 112 includes appropriate drivers for operation of the wireless module 94.

The power management controller 120 selectively receives input power from the battery pack 70 or external line voltage 134. The power management controller 120 includes appropriate circuits for converting the input power voltage to appropriate operating power required by each component of the communication space station 24. Additionally, the power management controller 120 includes appropriate circuits for managing charging of the battery pack 70 when the platform unit 52 is coupled to the line voltage 134 and generating appropriate power for operating and/or charging the modular docking interface 58 and the modular subscriber device 50 when coupled to the platform unit 52.

The communication controller 122 operatively couples the modular docking interface 58 and the modular subscriber device 50 to the application controller 112 such that the platform 52 can exchange data with the modular subscriber device 50. In the exemplary embodiment the communication controller is a serial communication controller that enables the serial exchange of data with a compatible serial communication controller within the modular subscriber device 50 over a physical medium. Exemplary physical mediums include hardwired contacts, an infrared transmission, and RF transmission, however other physical mediums are envisioned and the selection of a physical medium is not critical to this invention.

The network switch controller 124 provides a network data port 84 which enables the application controller 112 to communicate with another network computing circuit over a network interface. The network switch controller 124 is coupled to a bus port 135 within the function specific docking platform 74b for coupling to a mating port 148 on the function specific module 56.

The key switch (e.g. button) controller 126 is coupled to: 1) a connector 136a which in turn is coupled to a mating connector on the modular subscriber interface unit 60a (FIG. 3) for interconnecting the buttons 68 to the key switch controller 126; 2) a connector 136b which in turn is coupled to a mating connector 142 on the function specific module 54 for interconnecting the buttons 76 and 86 to the key switch controller 126; 3) the bus port 134 which in turn is coupled to a mating port 148 on the function specific module 56 for interconnecting the buttons 78 and 80 to the key switch controller 126; 4) the cell button 104; 5) and the help button 106. In the exemplary embodiment, the key switch controller 126 may drive row and column signals to the various buttons and, upon detecting a short between a row and a column (e.g. button activation) reports the button activation to the application controller 112 over the bus 116. Again, the application controller 112 includes appropriate drivers for operating the key switch controller 126.

The touch panel controller 128 is coupled to a connector 144 which in turn is coupled to a mating connector on the modular subscriber interface unit 60b (FIG. 3) for interconnecting the touch panel graphic display 72 to the touch panel controller 128. In the exemplary embodiment, the touch panel controller 128 may include a separate display control circuit compatible with the resolution and color depth of the touch panel graphic display 72 and a separate touch panel control circuit for detecting subscriber contact with the touch panel graphic display 72. The application controller 112 includes appropriate systems for driving the contents of the touch panel graphic display 72 through the touch panel controller 128.

The voice communication system 130 generates analog voice signals for driving the speaker 100 (or the speaker in the handset 98 of FIG. 3) and detects input from the microphone 102 (or the microphone in the handset 98) under the control the application controller 112.

The POTS converter circuit 146 provides a standard POTS port signal (e.g. tip and ring) for operation of a traditional telephone or a traditional fax machine coupled to a POTS port 82 on the function specific module 56. In operation the POTS converter 146 circuit interfaces between the POTS signal and the application controller 112.

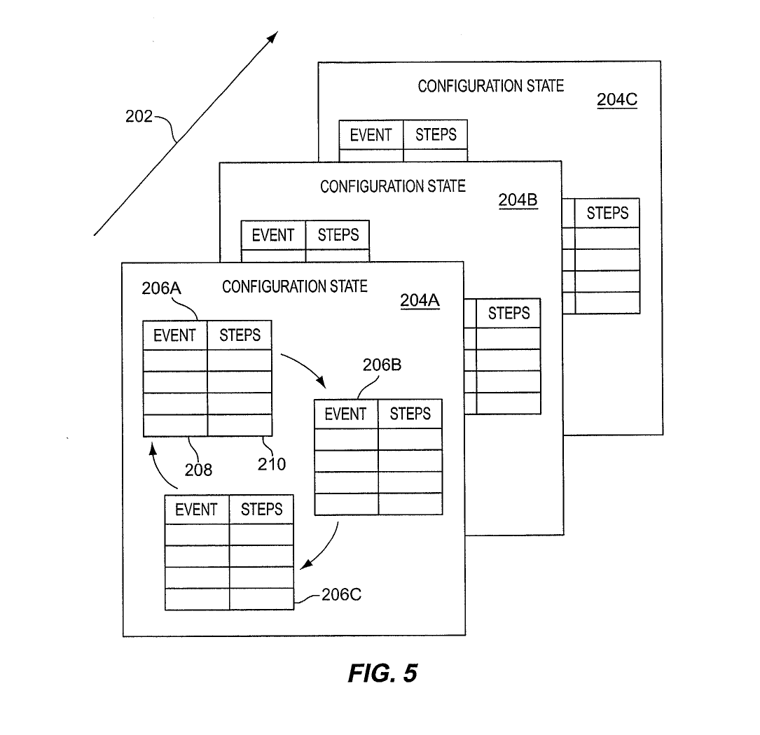

In the exemplary embodiment, the application controller 112 executes a packet voice communication client 113 and a management client 115. The packet voice communication client 113 provides for setting up and maintaining packet voice communications through the packet voice gateway 232 (FIG. 5) within the control unit 12. In the exemplary embodiment, the packet voice communication client may be one of the commercially available clients utilizing established protocols such as the International Telephone Union (ITU) H.323 protocols, The Internet Engineering Task Force (IETF) Session Initiation Protocols, or other protocols useful for signaling and establishing a real time streaming media session with the packet voice gateway 232.

The management client 115 provides for the controller 112 to execute processing steps in accordance with instructions received from the control unit 12. The processing steps may include executing control scripts or messages received from the control unit 12, generating an image on the touch panel graphic display 72 or on the graphic display 90 on the subscriber device 50 in accordance with display content messages and display layout control messages received from the control unit 12, playing a voice stream file received from the control unit 12 through the dialog system 130, executing scripts to activate the packet voice client 113 to set up a real time audio session with the packet voice gateway 232 (FIG. 5), providing messages to the control unit 12 indicating subscriber activation of the cell button 104, the help button 106, a touch panel virtual button, or any other button on the communication space station 24, identifying the modular configuration or subscriber interface configuration of the communication space station 24 and reporting the configuration to the control unit 12, and reporting the coupling of (and decoupling of) a subscriber device 50 and/or modules to the platform 52 of the communication space station 24 to the control unit 12.

Control Unit

FIG. 5 shows a block diagram of the control unit 12 in accordance with an exemplary embodiment of the present invention. As discussed previously, the control unit 12 includes a multi-media communication service provider bay 14 which operatively couples one of a plurality of communication medium modules 16 to the control unit 12 for providing an interface to a service provider's multi-media communication medium. The control unit 12 further includes a local area network management system 214, a voice converter circuit 218, a voice server 226, a packet voice gateway 232, a session control server 230, a messaging client 228, and a help file database 231.

The local area network management system 214 manages the communication of data between the control unit 12 and each of the local communication devices 20 (FIG. 1). The local area network management system 214 may include an address server 220 for assigning a network address (from a block of available network addresses) to each local communication device 20 upon the local communication device subscribing to the wireless network 22 and requesting a network address. The local area network management system 214 may also include a proxy server 222 for communicating with remote devices via the service provider multi-media communication medium 18 on behalf of each of the local communication devices 20.

A port control circuit 216 may interconnect the local area network management system 214 to each of the wireless network 22, the packet voice gateway 232, the session control server 230, and the messaging client 228 over standard network port connections.

The messaging client 228 provides for authenticating a subscriber to a remote messaging server (not shown) coupled to the service provider multi-media communication medium 18 and copying a plurality of subscriber messages from such messaging server. The voice server 226 provides voice prompts for providing a voice interface to accept a voice message for a subscriber, store the message as a digital file, and send the digital file to the remote messaging server associated with the subscriber. The session control server 230 operates the protocols for sending multi-media content messages and control messages to each local communication device 20 over the wireless local area network 22. In the exemplary embodiment, the communications between the session control server 230 and each local communication device occurs using tagged messages. The tag for each message identifies the content of the message to the recipient local communication device 20.

The packet voice gateway 232 provides real time voice communications between local communication devices 20 and between a local communication device 20 and a remote voice communication device over either the multi-media communication service provider medium 14 or the circuit switched channel 42.

The voice converter 218 functions to convert voice signals compatible with the circuit switched channel 42 to packet voice signals compatible with the voice server 226 and the packet voice gateway 232 and, in reverse, functions to convert packet voice signals to voice signals compatible with the circuit switched channel 42.

Each of the local area network management system 214, the packet voice gateway 232, the voice converter 218, the voice server 226, the session control server 230, and the messaging client 228 operate as an integrated system under the control of the session control server 230.

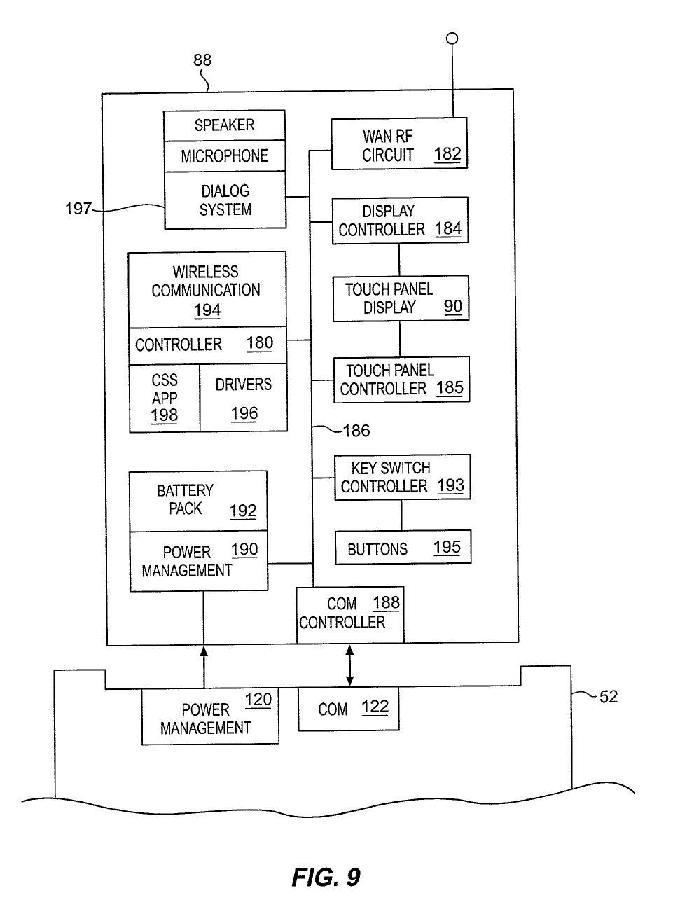

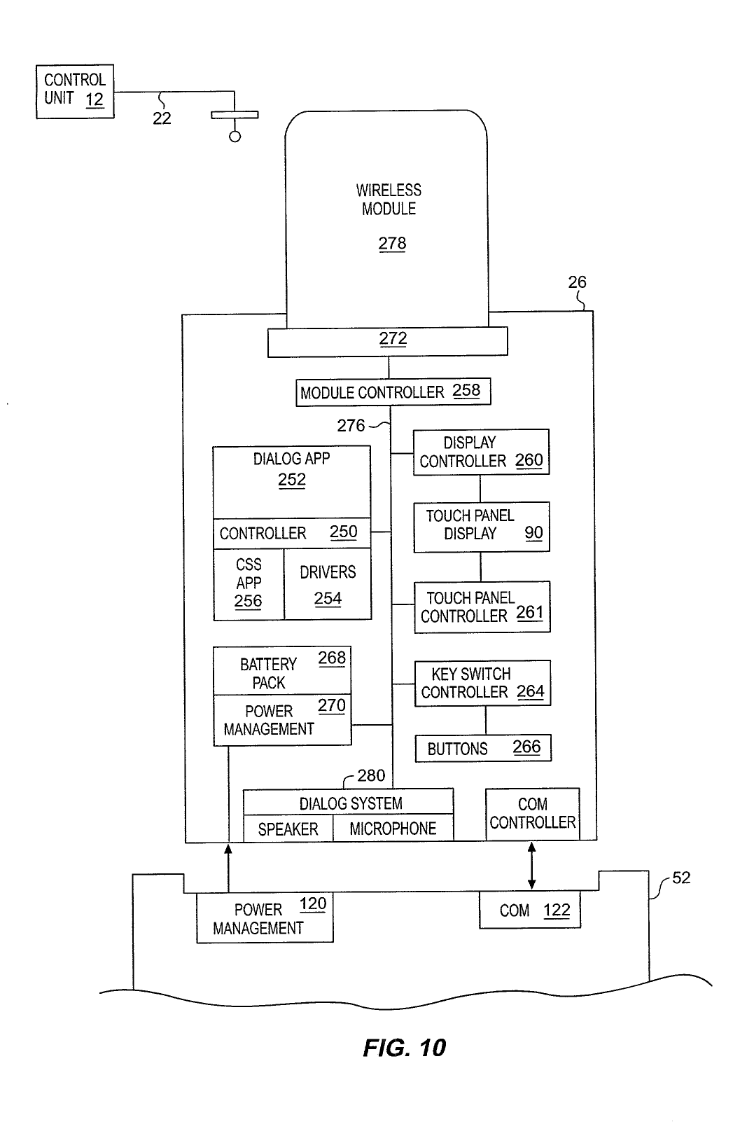

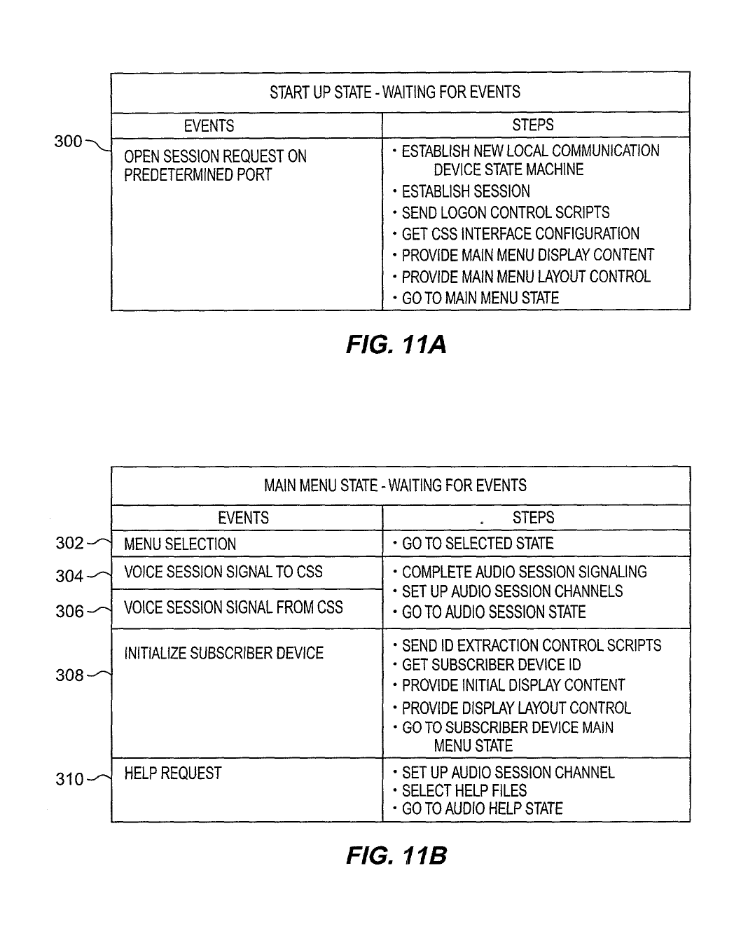

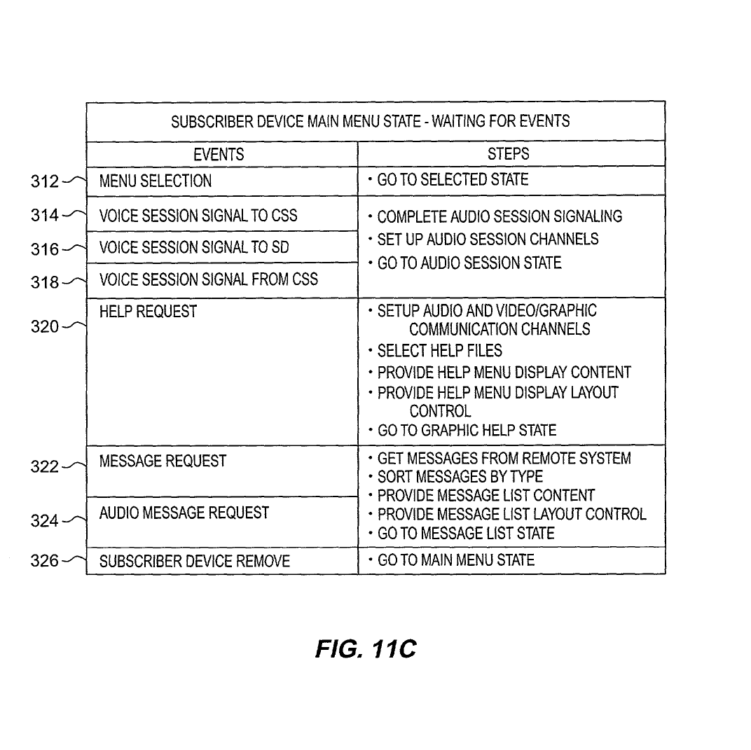

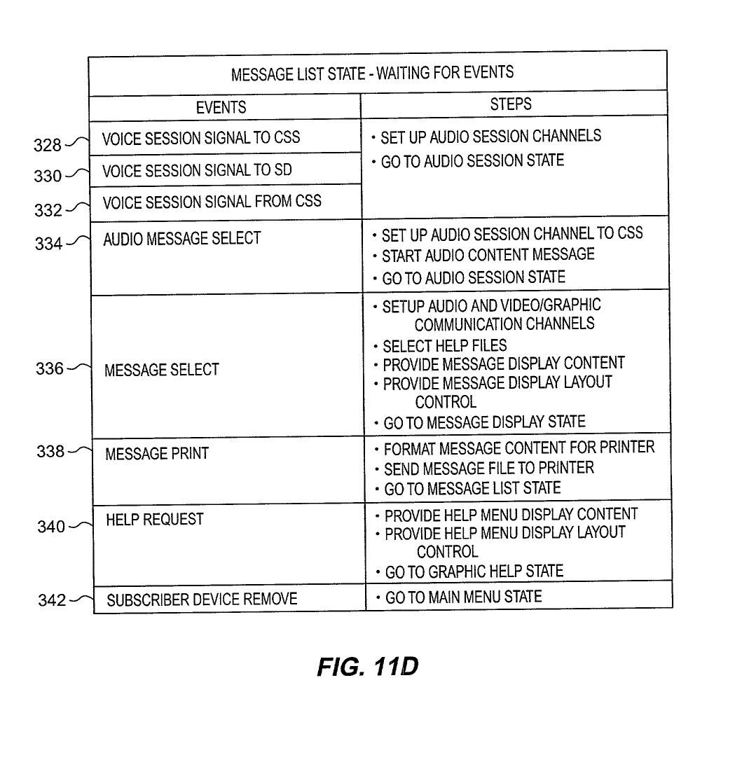

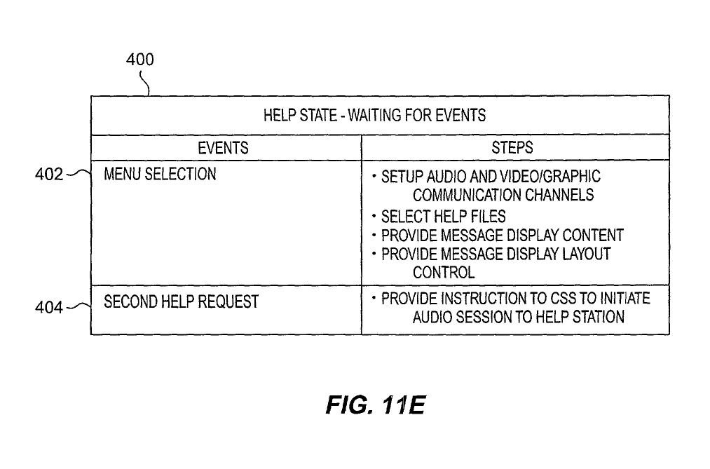

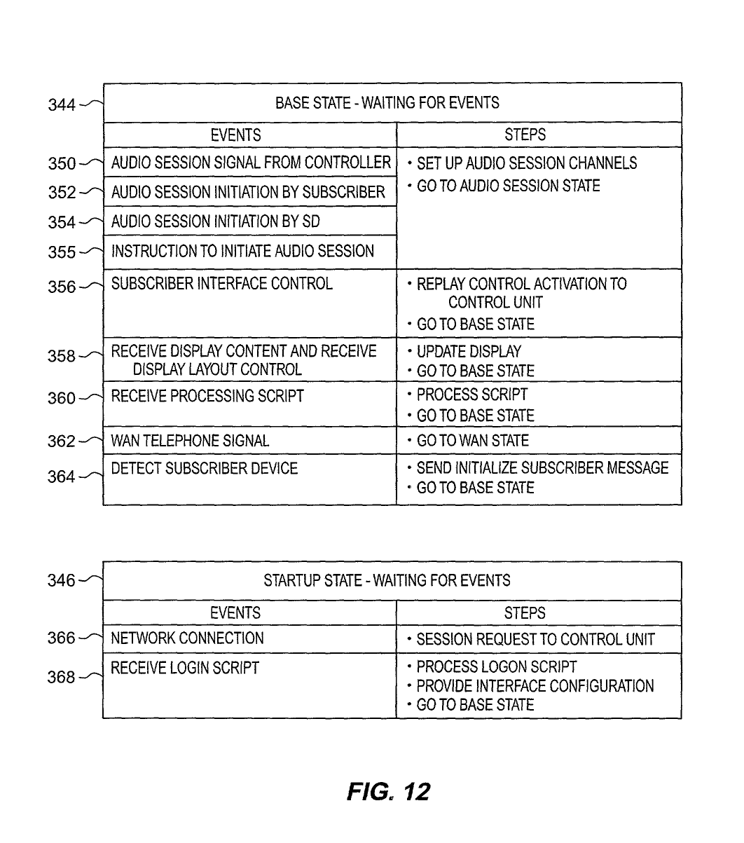

The session control server 230 operates as an event driven state machine. The state machine includes multiple processing states and when in each state, the session control server 230 recognizes various events. In response to each recognized event, the session control server 230 executes processing steps and may include transitioning to another state. The session control server 230 may navigate the state machine by transitioning between states independently for each local communication device 20 in response to event signals. During operation of the state machine for a particular local communication device 20, the session control server 230 receives event signals from each of the voice server 218, the messaging client 228, the session control server 230, the packet switched voice gateway 232, the multimedia communication service provider medium 18, and the local communication device 20. Exemplary states, processing steps, and events are discussed herein with respect to FIGS. 9a-9e.

Overview of Context Dependent Help

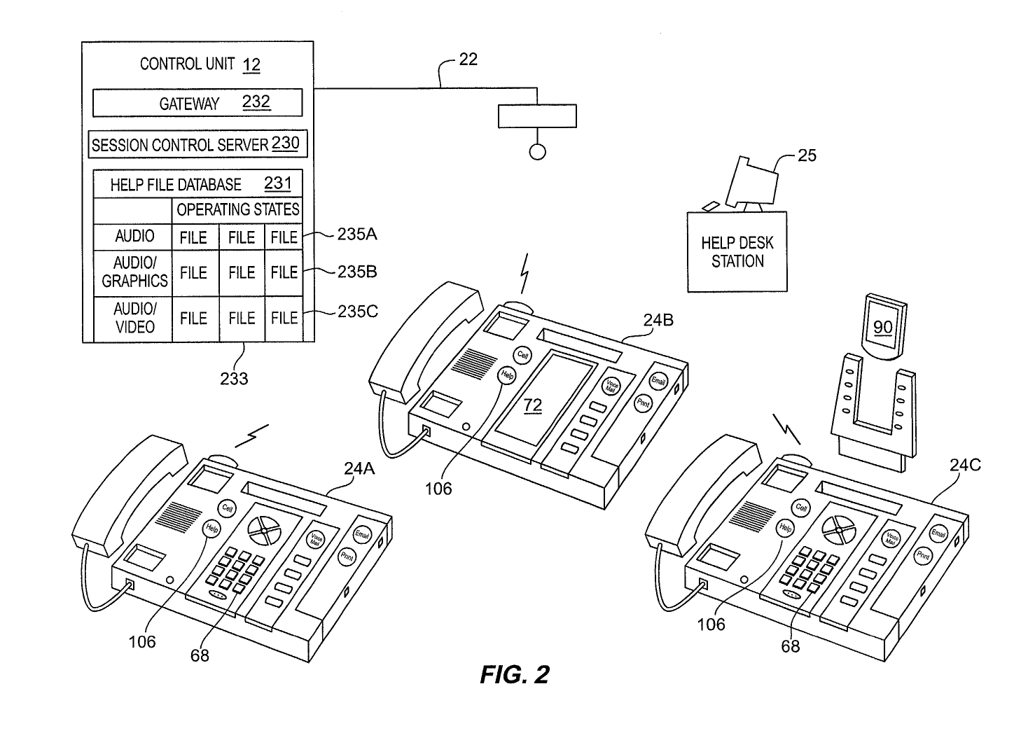

Referring to FIG. 2, the control unit 12 further provides context dependent help information to each communication space station 24 in response to subscriber activation of the help button 106 on the surface of the communication space station 24. The help content is delivered to a communication space station 24 in a format compatible with the subscriber interface configuration of such communication space station 24.

For example, communication space station 24a includes a subscriber voice interface 130 (FIG. 4) and does not include a display. As such, help content is delivered to communication space station 24a by the control unit 12 in a voice only format (possibly a .wav file, a .mp3 file, or similar).

Communication space station 24b includes both graphic display 72 (which for purposes of illustration is assumed to be a low resolution display that is incapable for displaying full motion video) and a subscriber voice interface 130 (FIG. 4). Help content is delivered to communication space station 24b by the control unit 12 as a sequence of at least one still graphic display (possibly a sequence of .jpg files, tif files, or similar) and a voice file (possible a .wav file, a .mp3 file, or similar) that is related to, and synchronized with, the sequence of still graphic displays.

Communication space station 24c serves a subscriber device 50 that includes a high resolution full motion display 90 and a subscriber voice interface 130 (FIG. 4). Help content is delivered to communication space station 24b by the control unit 12 as a full motion video and voice content that is related to and synchronized with the full motion video (possible a .avi file, a .mpg file, or similar).

In the above example, display 72 is assumed to be a low resolution display without the ability to display full motion vide and display 90 on the subscriber device 50 is assumed to have the ability to display full motion video, it is also envisioned that the display 72 on the communication space station 24 would have capability of displaying full motion video and that display 90 on the subscriber device may not have full motion video capability. In which case, the format of the help content would be selected accordingly.

Further, in the event that the subscriber activates the help button 106 on the communication space station 24 while the help content is being output by the subscriber station or within a predetermined period of time following the first activation of the help button 106, the session control server 230 will provide instructions to the communication space station 24 to establish a communication session with a help station 25 such that the subscriber may communicate directly with a help station representative.

The help file database 231 includes a plurality of help content files 233 which are shown organized in a matrix format for purposes of illustration. Each column of the help file database 231 represents one of a plurality of operational states in which each communication space station 24 may be operating under control of the session control server 230. Each file within a column includes help content file(s) related to the particular operational state. As such, when a subscriber activates the help button 106 on a communication space station 24, the help content delivered by the control unit 12 to the communication space station 24 will be content files that are located in the column that corresponds to the operational state of the communication space station 24 when the subscriber activated the help button 106.

Each row of the help file database 231 represents a file format for the help content. In particular, row 235a includes help content stored as a voice file that includes content useful to the subscriber when heard without reference to any display content. Row 235b includes the help content for each column stored as a sequence of still image files, a voice file that is related and references content of the image files, and a timing file that times the display of the image files to synchronize with the voice file. Row 235c includes the help content for each column stored in a full motion video file with corresponding synchronized voice content that relates to the video content and references the video content. While it is envisioned that both the full motion video and its corresponding audio are stored in a single file, it is possible for the two to be stored in separate files.

The session control server also stored the address of the help desk station.

Subscriber Data Assistant

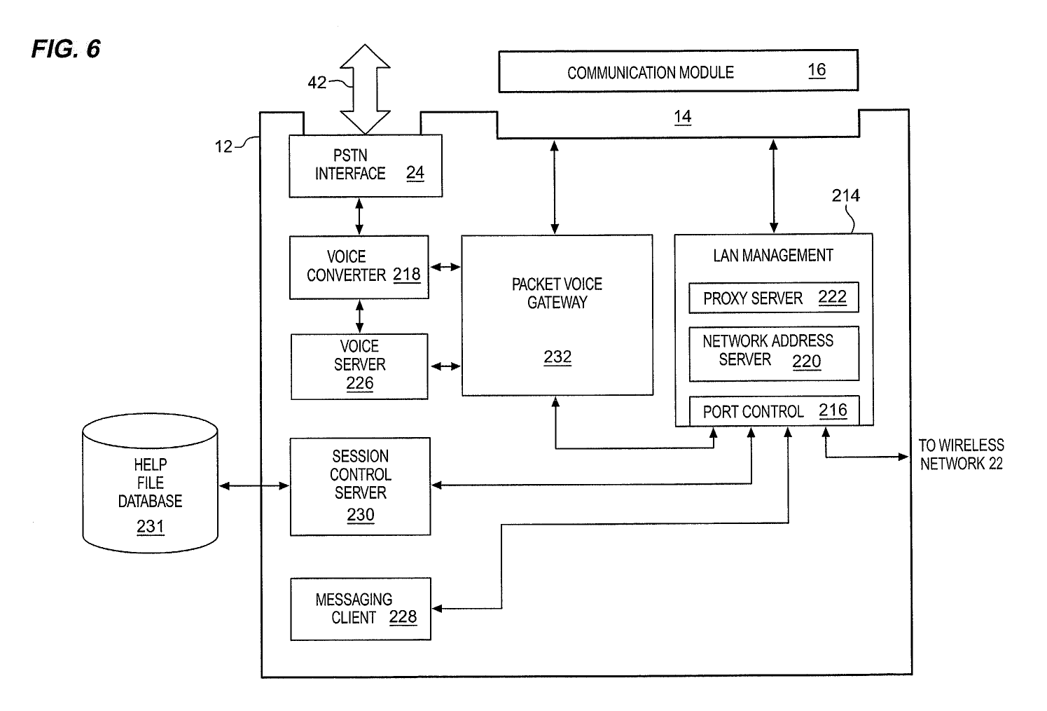

Turning to FIG. 6, exemplary structure of a subscriber data assistant 86 is shown. The subscriber data assistant 86 includes a controller 160 interconnected to a plurality of peripheral controllers by an internal bus 162. Because of the small size and the portability of the subscriber data assistant 86, the touch panel 90 provides the primary subscriber interface. The touch panel 90 is controlled by a display controller 164 and a touch panel controller 166. The display controller 164 drives the liquid crystal display of touch panel 90 using signals compatible with the resolution and color depth of the graphic display 90. The touch panel controller 166 detects user activation of the touch panel 90. The controller 160 operates appropriate drivers 176 for controlling operation of the touch panel controller 166 and the display controller 164.

A communication controller 168 is also coupled to the bus 162 and operates under control of the application controller 160. In the exemplary embodiment, the communication controller 168 is a serial communication controller that is compatible with the communication controller 122 of the platform unit 52 (both of FIG. 4) such that data communication may occur between the platform unit 52 and the subscriber data assistant 86 when the subscriber data assistant 86 is operatively coupled to the platform unit 52.

A power management circuit 170 selectively receives input power from a battery pack 172 or from the power management circuit 120 in the platform unit 52. The power management circuit 170 includes appropriate circuits for converting the input power voltage to appropriate operating power required by each component of the subscriber data assistant 86. Additionally, the power management circuit 170 includes appropriate circuits for managing charging of the battery pack 172 when subscriber data assistant is coupled to the platform unit 52.

The controller 160 also operates a communication space station client application 174 for displaying multi-media communication management information under control of the platform unit 52 when coupled to the platform unit 52. In the exemplary embodiment the communication space station client application 174 receives messages from the platform unit 52 in the form of tagged messages. After receipt of the tagged messages, the communication space station client application 174 builds a display document to display the communication management information represented by tagged content messages in accordance with display layout control messages that are compatible with the size, resolution, and color depth of the touch panel graphic display 90. The display document is then displayed on the touch panel graphic display 90.

It should be appreciated that in additional to operating the drivers 176 and the communication space station client application 174, the controller 160 may optionally operate any of the software applications that are commercially available for portable data assistants (PDAS) which may include address book management software, calendar management software, and games. While operation of such PDA applications may be useful to the subscriber, it is not critical to the operation of the present invention.

Subscriber Wide Area Network Communication Device

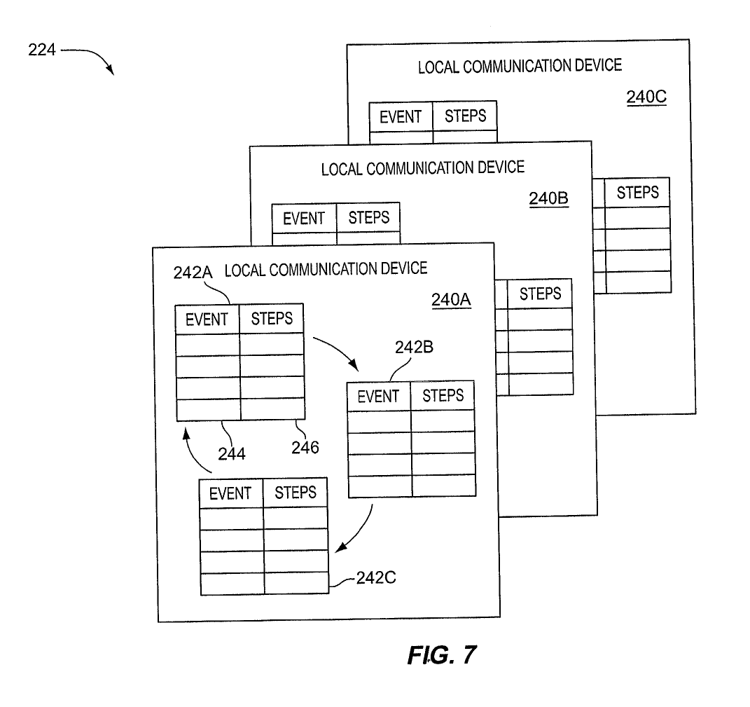

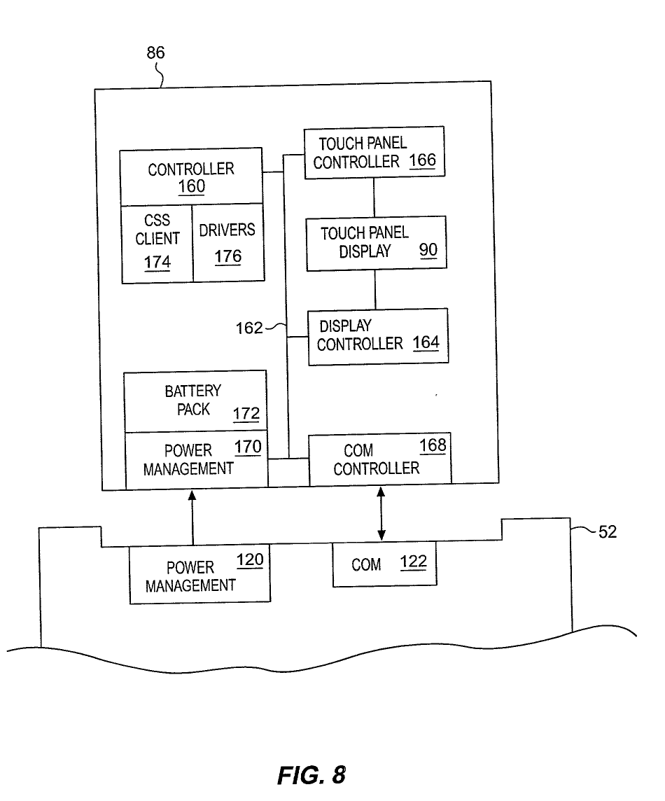

Turning to FIG. 7, exemplary structure of a subscriber wide area network communication device 88 is shown. The wide area network communication device 88 includes a controller 180 interconnected to a plurality of peripheral circuits by an internal bus 186. The peripheral circuits include a wide area network RF circuit 182, a voice system 197, a display controller 184, a key switch controller 193, a communication controller 188, and a power management system 190.

The wide area network RF circuit 182 may be a circuit for transmitting and receiving signals from a wide area network service provider's medium. Exemplary wide area network service provider mediums include an analog or digital cellular or PCS telephone RF system. The controller 180 controls the wide area network RF circuit 182 to effect such communication through a wireless communication application 194.

The key switch controller 193 is coupled to the control buttons 195. The key switch controller 193 operates under control of applicable drivers 196 to drive row and column signals to the control buttons 195 and, upon detecting a short between a row and a column indicating button activation, reports the activation to the controller 180. The control buttons may be used by a subscriber for operating the wide area network communication device 88 when uncoupled from the platform unit 52.

The voice system 197 includes a speaker and a microphone. Under control of the wireless communication application 194, the voice system 197 may provide a subscriber voice interface for a voice session with a remote device over the wide area network service provider's medium.

The display controller 184 operates under control of applicable drivers 146 to drive the graphic display 90 using signals compatible with the resolution and color depth of the graphic display 90. The graphic display 90 may optionally be a touch panel graphic display 90 and the touch panel controller 185, operating under control of applicable drivers 146, detects user activation of the touch panel 90.

The communication controller 188 also operates under control of applicable drivers 196 and may be a serial communication controller compatible with the communication controller 122 in the platform unit 52 such that data communication may occur between the platform unit 52 and the wide area network communication device 88 when the wide area network communication device is operatively coupled to the platform unit 52.

The power management controller 190 operating with a battery pack 192, both of which may operate in a similar manner to the power management controller 170, and the battery pack 172 discussed with reference to FIG. 7.

The controller 180 operates a wide area network communication space station client application 198. When the wide area network communication device 88 is coupled to the platform unit 52, the wide area network communication space station application 198 provides for displaying multi-media communication management information under control the platform unit 52 and provides for multimedia communication directly between the platform unit and the wide area network service provider medium.

The wide area network communication space station client application 198 may receive messages from the platform unit 52 which may be both multi-media communication for communication over the wide area network service provider medium or multi-media communication management information for display on the graphic display 90. Each message comprises a plurality of tagged messages wherein the tag identifies the contents of the message. After receipt of the tagged messages, the wide area network communication space station client application 198 identifies whether the message is for communication with the wide area network service provider medium or whether it is multi-media communication management information for display. If it is multi-media communication management information message for display, the wide area network communication space station client application 198 builds a document to display the communication management information represented by the tagged content messages in accordance with display layout control messages that are compatible with the size, resolution, and color depth of the touch panel graphic display 90. The display document is then displayed on the touch panel graphic display 90. Alternatively, if the message is for communication with the wide area network service provider medium, the controller 180 reformats the message to a format compatible with wide area network service provider medium transmission standards and transmits the message using the wide area network RF circuit 182.

The wide area network communication space station client application may also receive signals from the wide area network service provider medium via the wide area network RF circuit 182. When received, the wide area network communication space station client application 198 reformats the messages into a plurality of tagged messages for communication to the platform unit 52 and sends the tagged messages to the platform unit 52 via the communication controller 188.

Wireless Voice Handsets

FIG. 8 shows a block diagram of an exemplary wireless voice handset 26. The wireless voice handset 26 includes a network circuit 278 and a controller 250 interconnected by a bus 276 to a plurality of peripheral circuits which include a module controller 258, a display driver 260, a key switch controller 264, and a power management circuit 270. The module controller 258 operatively couples the network circuit 278 to the controller 250 such that the wireless voice handset 26 may communicate with the control unit 12 over the wireless LAN 22 (both of FIG. 1). In the exemplary embodiment, the module controller 258 may be a PCMCIA controller circuit and the network circuit 278 is configured as a PCMCIA card that coupled to the module controller 258 through a PCMCIA connector 272. The controller 250 includes a voice application 252 and appropriate drivers 254 for operating the network circuit 278 and communicating with the control unit 12 using appropriate wireless signaling protocols.

The key switch controller 264 is coupled to the control buttons 266. The key switch controller 264 drives row and column signals to the control buttons 266 and, upon detecting a short between a row and a column indicating button activation, reports the activation to the controller 250. The control buttons may be used by a subscriber for operating the wireless voice handset 26 when uncoupled from the platform unit 52.

The display controller 260 drives the graphic display 90 (optionally a touch panel graphic display 90) using signals compatible with the resolution and color depth of the graphic display 90 under the control of the drivers 254 operated by the controller 250. The optional touch panel controller 261 detects user activation of the touch panel graphic display 90. The power management controller 270 operates in conjunction with a battery pack 268, both of which may operate in a similar manner to the power management controller 170, and the battery pack 172 discussed with reference to FIG. 6.

The controller 250 operates in both two states, the coupled to a communication space station state and an uncoupled state. When in the coupled state, the controller 250 operates a wireless voice handset communication space station client application 256. When the wireless voice handset 26 is coupled to the platform unit 52, the wireless voice handset communication space station application 256 provides for displaying multi-media communication management information under control the platform unit 52. The wireless voice handset communication space station client application 250 may receive multi-media communication management information content messages and control messages from the control unit 12 via the wireless network 22. Each message comprises a plurality of tagged messages wherein the tag identifies the contents of the message. After receipt of the tagged messages, the wireless voice handset communication space station client application 256 builds a document to display the communication management information represented by the tagged content messages in accordance with display layout control messages that are compatible with the size, resolution, and color depth of the touch panel graphic display 90. The display document is then displayed on the touch panel graphic display 90.

When operating in the undocked state, the controller operates to interface voice communication between a voice communication system 280 (including a speaker and a microphone) and the control unit 12 via the wireless network 22.

Session Control State Machine

FIGS. 9a through 9d represent tables showing exemplary operational states of the session control server 230. Referring to the tables of FIGS. 9a through 9d in conjunction with the block diagram of FIG. 5, operation of the session control server 230 for providing exemplary multi-media communication management in accordance with the present invention is shown.

The table of FIG. 9a represents a start up state. In the start up state, the session control server 230 is waiting for an open session request from a new communication space station 24 on a predetermined port. When a communication space station 24 has just operatively coupled to the local area network 22, obtained a network address from the network address server 220, and is ready to operate, the management client 115 (FIG. 4) sends an open session request to a predetermined network address (matching that of the session control server 230) on the predetermined port. Event 300 represents receipt of an open session request from the subscriber station 24. In response to event 300, the session control server 230 performs various steps to initiate management control of multimedia communications of the communication space station 24 that include: i) establishing a session in response to the open session request; ii) sending control messages to the communication space station 24 that, when executed by the management client 115, providing for the communication space station 24 to detect its subscriber interface configuration (e.g. whether the communication space station 24 includes a display screen and what capabilities such as vide capabilities and graphic resolution capabilities the display screen may have) and to report its subscriber interface configuration back to the session control server 230; iii) obtaining the subscriber interface configuration; iv) providing main menu display content messages and main menu layout control messages to the communication space station 24 that are compatible with the particular display (if any) that is included in the subscriber interface reported by the communication space station 24; and transitioning to a main menu state as represented by FIG. 9b.

When in the main menu state, the session control server 230 is waiting for one of a plurality of events to occur that may include an event 302 that represents a message from the communication space station 24 indicating subscriber selection of a menu choice from the main menu, event 304 that represents receipt of a message from the communication space station 24 indicating that the communication space station 24 has begun a voice session between the communication space station 24 and the packet voice gateway 232, event 308 that represents a message from the communication space station 24 indicating that a subscriber device 50 has been operatively coupled to, and is ready to be served by, the communication space station 24, and event 310 that represents a message from the communication space station 24 indicating that the subscriber has activated a help control (for example, pressing the help button 106).

In response to event 302, the session control server 230 executes steps associated with the selected menu choice, and may transition to a state corresponding to the selected menu choice. For example, if one of the menu choices were to obtain stock quotes for a predetermined portfolio, obtain local weather, or obtain any other information from a predetermined Internet URL, the session control server would, in response to event 302 (e.g. the message from the communication space station 24 indicating the menu selection) establish a TCP/IP connection with the predetermined URL, obtain the information, provide the information in the form of content messages to the communication space station 24, and provide control messages to the communication space station 24 to output the content information through the audio interface or through a display screen if the communication space station 24 is configured with a subscriber interface that includes a display screen (as determined in steps performed following event 300 of FIG. 9a).

In response to event 304, the session control server 230 may query the packet voice gateway 232 to obtain information regarding the voice session such as telephone number (and name or person or company associated with the telephone number) of the other device that is participating in the session through the packet voice gateway 232, send content messages to the communication space station 24 that includes the information regarding the voice session, and send control messages to the communication space station 24 to output the content information on the display screen if the communication space station 24 is configures with a subscriber interface that includes a display screen.

In response to event 308 indicating that a subscriber device 50 has been coupled to the communication space station 24, the session control server 230 performs steps required to begin supporting the subscriber device 50 through the communication space station 24. Those steps may include: i) sending content and control messages to the communication space station 24 that represent a script for extracting identification information from the subscriber device 50 and represent an instruction to execute the scripts, ii) obtaining messages from the communication space station 24 that include information about the subscriber device (such as subscriber device ID and display resolution and video capabilities) that was provided by the subscriber device in response to the communication space station 24 executing the script, iii) providing content messages with subscriber device main menu content and control messages for displaying the subscriber device main menu content on the subscriber device 50 display screen in accordance with the display resolution and video capabilities; and iv) transitioning to the subscriber device main menu state as represented by FIG. 9c.

In response to event 310 that represents subscriber activation of a help control such as the help button 106 while in the main menu state, the session control server 230 selects help files 233 (FIG. 2) from the database 231 that include help content (e.g. column) content that is related to the operating state of the communication space station 24 and is in a format (e.g. row) that corresponds to the subscriber interface of the communication space station 24 as determined during steps associated with event 300 of FIG. 9a.

More specifically (with respect to selecting help content), the session control server 233 selects the help file 233 that is matched to the most recent message received from the communication space station 24 (except for the message indicating subscriber activation of the help control). For example, if the most recent message received from the communication space station 24 (prior to help control activation) was a menu selection, the session control server selects the help file 233 associated with such menu selection and, if the most recent message received from the communication space station 24 was an indication that a voice session has begun, the session control server selects the help file 233 associated with the beginning of a voice session while in the main menu state.

More specifically (with respect to selecting a format, the session control server utilizes the subscriber interface configuration information provided during execution of steps related to event 300 (initial logon) to determine whether the communication space station 24 is configured for an audio interface only, an audio interface with still image capabilities on a display screen, or an audio interface with full motion video display capabilities. The session control server then selects a file 233 that includes the content and that is either audio only, still image graphics with synchronized audio that references and explains the still image graphics, or full motion video with synchronized audio that references and explains the video images to match the subscriber interface capabilities of the communication space station 24.

Following selection of the help file 233, the session control server 230 will provide help content messages to the communication space station 24 and provide subscriber interface output control messages to the communication space station 24 to instruct the communication space station 24 to output the help content messages through the combination of the voice interface and the still image display or video display interface as applicable.

It should be appreciated that a portion of the help file 233 may include content that represents a menu of related help files. As such, after output of the help file 233 through the subscriber interface, the subscriber may select a related help file from such menu. In which case, the session control server 230 would select the related help file 233 that corresponds to the subscriber selection and execute the other steps associated with event 310. However, if another event 310 is received indicating that the subscriber has activated the help control a second time without an intervening selection or during a during a predetermined time period following the first activation of the help control, the session control server 230 will send control messages to the communication space station 24 instructing the communication space station 24 to establish an audio session with the help station 25 though the packet voice gateway 232 such that the subscriber may speak with the operator of the help station 25.

The subscriber device main menu state of FIG. 9c, is similar to the main menu state of FIG. 9b except that because the communication space station 24 is serving a subscriber device when in the subscriber device main menu state, additional functions may be available to the subscriber as menu choices. For example, a menu choice to access email messages or voice mail messages from mail boxes associated with the subscriber device may be included. When in the subscriber device main menu state, the session control server 230 is waiting for one of the events associate with the subscriber device main menu state that include event 302, which like the main menu state, represents a message from the communication space station 24 indicating subscriber selection of a menu choice, event 304, which like the main menu state, represents a message from the communication space station 24 indicating that the communication space station 24 has begun a voice session between the communication space station 24 and the packet voice gateway 232, event 310, which like the main menu state, represents a message from the communication space station 24 indicating that the subscriber has activated a help control (for example, pressing the help button 106), and event 326 that represents a message from the communication space station 24 indicating that the subscriber device 50 has been decoupled from the communication space station 24 is no longer served by the subscriber station 24.

Events 302, 304, and 310 are the same as in the main menu state and the response of the session control server 230 will be the same as discussed above with respect to FIG. 9b and will not be repeated for sake of brevity. However, because of the additional functions available when the communication space station 24 is serving a subscriber device, event 302, which represents a message indicating subscriber selection of menu choice may include event 302a which represents subscriber selection of a choice to obtain messages (such as by activation of the menu choice on a touch panel of the subscriber device 50 or by activation of an email button 78 as shown in FIG. 3) and may include event 302b which represents subscriber selection of a choice to obtain voice messages (such as by activation of the menu choice on a touch panel of the subscriber device 50 or by activation of a voice mail button 76 as shown in FIG. 3).

In response to events 302a or 302b the session control server 230 obtains messages associated with the subscriber device 50 from a remote messaging server coupled to the service provider medium, sorts the messages in accordance with the message type selection, provide messages representing message list display content and message list display layout control in accordance with the parameters of the graphic display 90 on the subscriber device 50, and then transitions to a message list state (FIG. 9d). In response to event 326 the control unit transitions to the main menu state (FIG. 9b).

When in the message list state of FIG. 9d, the list of messages is displayed on the subscriber device 50 and the session control server 230 is waiting for one of the events associated with the message list state. The events include event 304, which like the main menu state, represents a message from the communication space station 24 indicating that the communication space station 24 has begun a voice session between the communication space station 24 and the packet voice gateway 232, event 310, which like the main menu state, represents a message from the communication space station 24 indicating that the subscriber has activated a help control (for example, pressing the help button 106), and event 326, which like the subscriber device main menu state, represents a message from the communication space station 24 indicating that the subscriber device 50 has been decoupled from the communication space station 24 is no longer served by the subscriber station 24. The events further include event 334 that represents a message indicating that the subscriber has activated a control to obtain a voice message from the list, event 336 that represents a message indicating that the subscriber has activated a control to display a message from the list, and event 338 representing a message indicating that the subscriber has activated a control to print a message from the list.

Events 304, 310, and 326 are the same as in the main menu state or the subscriber device main menu state and the response of the session control server 230 will be the same as discussed above. Therefore the discussion will not be repeated for sake of brevity.

In response to event 334 the session control server 230 sends the contents of the selected audio message to the communication space station 24 and sends control messages to instruct the communication space station 24 to output the audio content through the voice interface 130 (FIG. 4). In response to event 336 the session control server 230 provides messages representing the message display content and the message display layout control that are compatible with parameters of the graphic display 90 on the subscriber device 50. In response to event 338, the session control server 230 formats the selected message into a printer compatible file and sends the print file to a printer coupled to the network 22.

It should be appreciated that the systems and methods of the present invention provide for the communication and control of multi-media messages by a central control unit and for the provision of context dependent help services in an audio/visual format that is optimized for the audio/visual subscriber interface configuration of a particular communication space station served by the central control unit.

Although the invention has been shown and described with respect to certain preferred embodiments, it is obvious that equivalents and modifications will occur to others skilled in the art upon the reading and understanding of the specification. For example, the above described processing states, events, and processing steps for both the subscriber station 42 and the session control server 230 are exemplary states only for demonstrating operation and are not intended to limit the scope of the present invention. It is envisioned that after reading and understanding the present invention those skilled in the art may envision other processing states, events, and processing steps to further the objectives of the modular multi-media communication management system of the present invention. The present invention includes all such equivalents and modifications, and is limited only by the scope of the following claims.

What is claimed:

1. A multi-media communication management system for operation with a plurality of subscriber stations, at least one of which is a configurable subscriber station that includes a subscriber interface selected from a subscriber voice interface, a graphic display and a subscriber voice interface, a high resolution full motion display and a subscriber voice interface, the multi-media communication management system comprising:
a network communication circuit for multi-media communication with said plurality of subscriber stations;
a session control circuit for establishing a communication session with each subscriber station through the network communication circuit comprising:
a subscriber communication state manager for communicating control messages to a configurable subscriber station for controlling operational states of said configurable subscriber station and for receiving a help function request from said configurable subscriber station;
means for identifying the subscriber interface of said configurable subscriber station; and
means, responsive to said help function request, for providing help information to said configurable subscriber station that is related to the operational state of said subscriber station and is in a multimedia format compliant with the subscriber interface of the configurable subscriber station.

2. The multi-media communication management system of claim 1, wherein the means for providing help information comprises:
means for selecting a help content file from a database of help content files, said selected help content file being associated with the operational state of said configurable subscriber station and in a file format that can be output through the subscriber interface of the configurable subscriber station; and
means for sending a content message, including at least a portion of the help content file, to said configurable subscriber station; and
means for sending a control message to said configurable subscriber station that instructs said configurable subscriber station to output said at least a portion of the help content file contained in said content message through the subscriber interface.

3. The multi-media communication management system of claim 2, wherein the selected help content file includes at least one of:
a video file for output on the high resolution full motion display and a voice file, including voice information related to and synchronized with the video file for output through the subscriber voice interface if the subscriber interface is a high resolution full motion display and subscriber voice interface;
at least one graphic display file for output on the graphic display and a voice file, including voice information related to the at least one graphic display file, for output through the subscriber voice interface if the subscriber interface is a graphic display and subscriber voice interface; and
a voice file for output through the subscriber voice interface if the subscriber interface is a subscriber voice interface.

4. The multi-media communication management system of claim 3, wherein the selected help content file includes a sequence of still graphic display files for output on the graphic display and a voice file, including voice information that is related to and synchronized with the sequence of still graphic display files for output through the subscriber voice interface if the subscriber interface is a graphic display and subscriber voice interface.

5. The multi-media communication management system of claim 4, wherein the help function request is a message provided by the configurable subscriber station indicating that a subscriber has activated a help button on the subscriber station.

6. The multi-media communication management system of claim 5, wherein the session control server further comprises:
means for sending a control message to the configurable subscriber station that instructs the configurable subscriber station to establish a communication session with a help station in response to a help function request from the configurable subscriber station occurring while said at least a portion of the help content file contained in said content message is being output through the subscriber interface.

7. The multi-media communication management system of claim 1, wherein the help function request is a message provided by the configurable subscriber station indicating that a subscriber has activated a help button on the subscriber station.

8. The multi-media communication management system of claim 7, wherein the session control server further comprises:
means for sending a control message to the configurable subscriber station that instructs the configurable subscriber station to establish a communication session with a help station in response to a help function request from the configurable subscriber station occurring while said at least a portion of the help content file contained in said content message is being output through the subscriber interface.

9. A multi-media communication management system for operation with a plurality of subscriber stations, each of which includes a help button and a multimedia subscriber interface, the multi-media communication management system comprising:
a network communication circuit for multi-media communication with said plurality of subscriber stations;
a session control circuit for establishing a communication session with each subscriber station through the network communication circuit comprising:
a subscriber communication state manager for communicating control messages to each subscriber station for controlling the operational state of each subscriber station independent of each other subscriber station and for receiving an indication of subscriber activation of the help button on an identified subscriber station;
means for providing multimedia help information to the identified subscriber station that is related to the operational state of the identified subscriber station in response to a first receipt of the indication of subscriber activation of the help button on the identified subscriber station;
means for sending a control message to the identified subscriber station that instructs the identified subscriber station to establish a communication session with a help station in response to a second receipt of the indication of subscriber activation of the help button on the identified subscriber station.

10. The multi-media communication management system of claim 9, wherein the second receipt of the indication of subscriber activation of the help button occurs within a predetermined time window following the first subscriber activation of the help button.

11. A method of providing context dependent help services to a configurable subscriber station that includes a subscriber interface selected from a subscriber voice interface, a graphic display and subscriber voice interface, a high resolution full motion display and subscriber voice interface, the method comprising:
communicating control messages to the configurable subscriber station over a network communication circuit for controlling operational states of the configurable subscriber station;
receiving a help function request from the configurable subscriber station over the network communication circuit;
identifying the subscriber interface of the configurable subscriber station;
providing, in response to a help function request, help information to the configurable subscriber station that is related to the operational state of the configurable subscriber station and is in a multimedia format compliant with the subscriber interface of the configurable subscriber station.

12. The method of providing context dependent help services to a configurable subscriber station of claim 11, wherein the step of providing help information comprises:
selecting a help content file from a database of help content files, said selected help content file being associated with the operational state of the configurable subscriber station and in a file format that can be output through the subscriber interface of the configurable subscriber station;
sending a content message including at least a portion of the help content file to said configurable subscriber station; and
sending a control message to said configurable subscriber station that instructs the configurable subscriber station to output said at least a portion of the help content file contained in said content message through the subscriber interface.

13. The method of providing context dependent help services to a configurable subscriber station of claim 12, wherein the selected help content file includes at least one of:
a video file for output on the high resolution full motion display and a voice file, including voice information related to and synchronized with the video file for output through the subscriber voice interface if the subscriber interface is a high resolution full motion display and subscriber voice interface;
at least one graphic display file for output on the graphic display and a voice file, including voice information related to the at least one graphic display file, for output through the subscriber voice interface if the subscriber interface is a graphic display and subscriber voice interface; and
a voice file for output through the subscriber voice interface if the subscriber interface is a subscriber voice interface.

14. The method of providing context dependent help services to a configurable subscriber station of claim 13, wherein the selected help content file includes a sequence of still graphic display files for output on the graphic display and a voice file, including voice information that is related to and synchronized with the sequence of still graphic display files for output through the subscriber voice interface if the subscriber interface is a graphic display and subscriber voice interface.

15. The method of providing context dependent help services to a configurable subscriber station of claim 14, wherein the help function request is a message provided by the configurable subscriber station indicating that a subscriber has activated a help button on the subscriber station.

16. The method of providing context dependent help services to a configurable subscriber station of claim 15, further including:
sending a control message to the configurable subscriber station that instructs the configurable subscriber station to establish a communication session with a help station in response to a help function request from the configurable subscriber station occurring while said at least a portion of the help content file contained in said content message file is being output through the subscriber interface.

17. The method of providing context dependent help services to a configurable subscriber station of claim 11, wherein the help function request is a message provided by the configurable subscriber station indicating that a subscriber has activated a help button on the subscriber station.

18. The method of providing context dependent help services to a configurable subscriber station of claim 17, further including:
sending a control message to the configurable subscriber station that instructs the configurable subscriber station to establish a communication session with a help station in response to a help function request from the configurable subscriber station occurring while said at least a portion of the help content file contained in said content message is being output through the subscriber interface.

19. A method of providing help services to a plurality of subscriber stations, each of which includes a help button and a multimedia subscriber interface, the method comprising:
communicating control messages to each subscriber station for controlling the operational state of each subscriber station independent of each other subscriber stations;
receiving a first and a second indication of subscriber activation of the help button on an identified subscriber station;
providing multimedia help information to the identified subscriber station that is related to the operational state of the identified subscriber station in response to a first receipt of the indication of subscriber activation of the help button on the identified subscriber station; and
sending a control message to the identified subscriber station that instructs the identified subscriber station to establish a communication session with a help station in response to a second receipt of the indication of subscriber activation of the help button on the identified subscriber station.

20. The method of providing help services of claim 19, wherein the second receipt of the indication of subscriber activation of the help button occurs within a predetermined time window following the first subscriber activation of the help button.
